(19) United States
(12) Patent Application Publication
(10) Pub. No.: US 2007/0248873 A1
(43) Pub. Date: Oct. 25, 2007

(54) MEMBRANE-ELECTRODE ASSEMBLY FOR A DIRECT OXIDATION FUEL CELL AND A DIRECT OXIDATION FUEL CELL SYSTEM COMPRISING THE SAME

(76) Inventors: In-Hyuk Son, Yongin-si (KR); Sang-Il Han, Yongin-si (KR)

Correspondence Address: CHRISTIE, PARKER & HALE, LLP, PO BOX 7068, PASADENA, CA, 91109-7068, US

(21) Appl. No.: 11/688,814

(22) Filed: Mar. 20, 2007

(30) Foreign Application Priority Data
Apr. 19, 2006 (KR) 10-2006-0035304

(51) Int. Cl. H01M 4/90; H01M 4/92; H01M 4/96

(52) U.S. Cl. 429/40; 429/44

(57) ABSTRACT

A membrane-electrode assembly for a direct oxidation fuel cell and a direct oxidation fuel cell system including the same. The membrane-electrode assembly includes an anode and a cathode facing each other and a polymer electrolyte membrane interposed therebetween. The cathode includes an electrode substrate including a hydrocarbon fuel oxidizing catalyst and a cathode catalyst layer disposed on the electrode substrate.

### CROSS-REFERENCE TO RELATED APPLICATION

This application claims priority to and the benefit of Korean Patent Application No. 10-2006-0035304, filed in the Korean Intellectual Property Office on Apr. 19, 2006, the entire content of which is incorporated herein by reference.

### BACKGROUND OF THE INVENTION

1. Field of the Invention

The present invention relates to a membrane-electrode assembly (MEA) for a direct oxidation fuel cell (DOFC) and a DOFC system comprising the same. More particularly, the present invention relates to an MEA for preventing fuel cross-over and implementing high power, and a DOFC system comprising the same.

2. Description of the Related Art

A fuel cell is a power generation system for producing electrical energy through an electrochemical redox reaction of an oxidant and a fuel such as hydrogen, or a hydrocarbon-based material such as methanol, ethanol, natural gas, and the like. Such fuel cells are a clean energy source that can replace fossil fuels. They include a stack composed of unit cells and produce various ranges of power output. Since they have four to ten times higher energy density than a small lithium battery, they have been highlighted as small portable power sources.

Representative fuel cells include a polymer electrolyte membrane fuel cell (PEMFC) and a DOFC. The DOFC includes a direct methanol fuel cell that uses methanol as a fuel.

The PEMFC has an advantage of a high-energy density and high power but also has problems in the need to carefully handle hydrogen gas, and the requirement of accessory facilities such as a fuel reforming processor for reforming methane or methanol, natural gas, and the like in order to produce hydrogen as the fuel gas.

In comparison, a DOFC has a lower energy density and power than that of the gas-type fuel cell and needs a large amount of catalysts. However, it has the advantages of easy handling of the liquid-type fuel, a low operating temperature, and no need for additional fuel reforming processors.

The above information disclosed in this Background section is only for enhancement of understanding of the background of the invention, and therefore it should be understood that the above information may contain information that does not form the prior art that is already known in this country to a person of ordinary skill in the art.

### SUMMARY OF THE INVENTION

One embodiment of the present invention provides an MEA for a DOFC which is free from a problem occurring when a hydrocarbon fuel is crossed over toward a cathode. Another embodiment of the present invention provides a DOFC system having a high power output.

According to one embodiment of the present invention, an MEA for a fuel cell is provided that includes an electrode substrate including an anode and a cathode facing each other, and a polymer electrolyte membrane disposed therebetween. The cathode includes an electrode substrate including a hydrocarbon fuel catalyst and a catalyst layer disposed on the electrode substrate.

According to another embodiment of the present invention, a DOFC system is provided that includes an electricity generating element including the membrane-electrode assembly and that generates electricity through oxidation of a fuel and reduction of an oxidant, a fuel supplier for supplying the fuel to the electricity generating element, and an oxidant supplier for supplying the oxidant to the electricity generating element.

The DOFC system of the present invention may be a passive type (or an air-breathing type), which supplies an oxidant not by a pump but by a diffusion method.

### BRIEF DESCRIPTION OF THE DRAWINGS

FIG. 1 is a schematic view of a fuel cell system according to the present invention.

FIG. 2 shows a methanol oxidation conversion rate of the cathode substrate according to Example 1 of the present invention.

### DETAILED DESCRIPTION

Generally, a DOFC uses a hydrocarbon fuel, and accordingly it has side reaction problems in which the hydrocarbon fuel lowers the potential difference and generates heat, as the hydrocarbon fuel is crossed over toward a cathode and is oxidized. It also has another problem of decreased power output, as a cathode catalyst participates in oxidation of the hydrocarbon fuel as well as reduction of an oxidant. Particularly, a passive type DOFC uses a highly concentrated hydrocarbon fuel and has a problem in that some non-oxidized hydrocarbon fuel is leaked through a separator vent supplying an oxidant, and is then gasified.

In order to solve these problems, the present invention provides an MEA that is suitable for a DOFC, and particularly for a passive type of fuel cell.

The membrane-electrode assembly of the present invention includes an anode and a cathode facing each other, and a polymer electrolyte membrane interposed therebetween.

In an embodiment, the cathode of the present invention includes an electrode substrate including a hydrocarbon fuel oxidizing catalyst and a catalyst layer disposed on the electrode substrate. The hydrocarbon fuel oxidizing catalyst causes chemical oxidation with air.

In one embodiment, the hydrocarbon fuel oxidizing catalyst includes a first catalyst selected from the group consisting of Rh, Pd, Ir, Au, and a combination thereof, and a platinum-based second catalyst. In another embodiment, the first catalyst may be selected from the group consisting of Rh, Pd, Ir, and combinations thereof. In an embodiment, the first and second catalysts may be included in a mixing ratio of 5 to 20:95 to 80 wt %. When the amount of the first catalyst is less than 5 wt %, the hydrocarbon fuel may have deteriorated oxidation ability, while when it is more than 20 wt %, the catalyst effect may not increase in proportion to the increased amount.

In one embodiment, the second catalyst may include Pt, Ru, osmium, platinum-ruthenium alloys, platinum-osmium alloys, platinum-palladium alloys, platinum-M alloys, or combinations thereof, where M is at least one transition element selected from the group consisting of Ga, Ti, V, Cr, Mn, Fe, Co, Ni, Cu, Zn, Sn, Mo, W, Rh, and combinations thereof.

According to one embodiment, the hydrocarbon fuel oxidizing catalyst may include Ir as a first catalyst and Pt as a second catalyst.

In another embodiment, the carrier may include an inorganic material such as Al₂O₃, zeolites, TiO₂, SiO₂, MnO₂, Mn₂O₃, or zirconias, or a carbon compound such as acetylene black, denka black, activated carbon, ketjen black, and graphite. It can also include mixtures of more than one thereof.

In one embodiment, the hydrocarbon fuel oxidizing catalyst may be included in the electrode substrate in an amount ranging from 1 to 10 wt %. When the amount of the catalyst is less than 1 wt % the catalyst may have little effect, while when it is more than 10 wt %, the catalyst effect may not increase in proportion to the increased amount.

In an embodiment, a conductive substrate is used for the electrode substrate, for example, carbon paper, carbon cloth, carbon felt, or metal cloth on a porous film comprising metal cloth fiber or a metalized polymer fiber, but it is not limited thereto.

The electrode substrate may be treated with a fluorine-based resin to be water-repellent. According to one embodiment of the present invention, such water-repellent treatment may be performed before or after impregnation of the hydrocarbon fuel oxidizing catalyst. The water-repellent treated electrode substrate can prevent deterioration of reactant diffusion efficiency due to water generated during a fuel cell operation. The fluorine-based resin may include, but is not limited to, polytetrafluoroethylene (PTFE), polyvinylidene fluoride, polyhexafluoropropylene, polyperfluoro alkylvinylether, polyperfluorosulfonylfluoride alkoxyvinyl ether, fluorinated ethylene propylene, polychlorotrifluoroethylene, or a copolymer thereof.

In an embodiment, a microporous layer (MPL) can be added between the electrode substrate and catalyst layer to increase reactant diffusion effects. In general, the microporous layer may include, but is not limited to, a small-size conductive powder such as a carbon powder, carbon black, acetylene black, activated carbon, carbon fiber, fullerene, nano-carbon, or a combination thereof. The nano-carbon may include a material such as carbon nanotubes, carbon nanofiber, carbon nanowire, carbon nanohorns, carbon nanorings, or combinations thereof.

In an embodiment, the microporous layer is formed by coating a composition including a conductive powder, binder resin, and solvent on the conductive substrate. The binder resin may include, but is not limited to, polytetrafluoro ethylene (PTFE), polyvinylidene fluoride, polyhexafluoro propylene, polyperfluoroalkylvinyl ether, polyperfluoro sulfonyl fluoride, alkoxyvinylether, polyvinylalcohol, celluloseacetate, and copolymers thereof. The solvent may include, but is not limited to, an alcohol such as ethanol, isopropyl alcohol, ethyl alcohol, n-propyl alcohol, or butyl alcohol; water; dimethylacetamide (DMAc); dimethyl formamide, dimethyl sulfoxide (DMSO); N-methylpyrrolidone; or tetrahydrofuran. The coating method may include, but is not limited to, screen printing, spray coating, doctor blade methods, and so on, depending on the viscosity of the composition.

Since the present invention uses an electrode substrate coated with the hydrocarbon fuel oxidizing catalyst and can thereby oxidize the hydrocarbon fuel that has crossed over to a cathode and release it as CO₂ and H₂O, the present invention can prevent the hydrocarbon fuel from leaking or gasifying and also achieve a high power output by using the heat generated from the oxidization of the hydrocarbon fuel.

According to one embodiment of the present invention, a method of fabricating an electrode substrate includes coating a catalyst solution for oxidizing a hydrocarbon fuel on a substrate and heating it. In an embodiment, the coating method includes an impregnation method, a screen printing method, a spray coating method, or a doctor blade method.

The catalyst solution for oxidizing a hydrocarbon fuel is prepared by mixing a precursor of a hydrocarbon fuel oxidizing catalyst and a solvent. The catalyst precursor for oxidizing a hydrocarbon fuel may include at least one selected from the group consisting of a chloride of a hydrocarbon fuel oxidizing catalyst, carbide, nitride, cyan, and hydrates thereof. The solvent may include water, ethanol, methanol, or isopropyl alcohol. The catalyst solution for oxidizing a hydrocarbon fuel can be appropriately regulated in a concentration sufficient for coating.

Next, the heat-treatment process reduces a precursor of a hydrocarbon fuel oxidizing catalyst to a hydrocarbon fuel oxidizing catalyst, to form it on an electrode substrate. The heat-treatment process can also improve adherence of the hydrocarbon fuel oxidizing catalyst and the electrode substrate. The heat-treatment process may be performed at 150 to 800° C. under a reduction atmosphere such as a hydrogen atmosphere. When the heat-treatment process is performed at less than 150° C., a precursor may not be well reduced, while when it is at more than 800° C., the hydrocarbon fuel oxidizing catalyst can be sintered, resulting in large particles.

In one embodiment, the coating and heat-treatment process may be performed before performing a water-repellent treatment or forming a microporous layer. Alternatively, the coating and heat-treatment process may be performed after performing a water-repellent treatment or forming a microporous layer. The above water-repellent treatment and microporous layer formation processes are known well in this art, so they are omitted from this description.

Catalyst layers of a cathode and anode may include, but are not limited to, catalysts selected from the group consisting of platinum, ruthenium, osmium, platinum-ruthenium alloys, platinum-osmium alloys, platinum-palladium alloys, and platinum-M alloys, and combinations thereof, where M is at least one metal selected from the group consisting of Ga, Ti, V, Cr, Mn, Fe, Co, Ni, Cu, Zn, Sn, Mo, W, Rh, and combinations thereof. In an embodiment, specific examples of the catalyst may selected from the group consisting of Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, and combinations thereof.

In a further embodiment, the metal catalyst may be used as a black type or a supported type on a carrier. The carrier may generally include a carbon-based material such as graphite, denka black, ketjen black, acetylene black, carbon nanotubes, carbon nanofiber, carbon nanowire, carbon nanoballs, or activated carbon. For the carrier, an inorganic particulate such as alumina, silica, zirconia, or titania may also be used.

The catalyst layer may further include a binder resin to improve its adherence and proton transfer properties.

In an embodiment, the binder resin may be proton conductive polymer resins having a cation exchange group selected from the group consisting of a sulfonic acid group, a carboxylic acid group, a phosphoric acid group, a phosphonic acid group, and derivatives thereof at its side chain. Non-limiting examples of the polymer include at least one proton conductive polymer selected from the group consisting of perfluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In an embodiment, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), or poly(2,5-benzimidazole).

In an embodiment, the hydrogen (H) in the ionic exchange group of the terminal end of the proton conductive polymer side chain can be substituted with Na, K, Li, Cs, or tetrabutylammonium. When the H in the ionic exchange group of the terminal end of the proton conductive polymer side is substituted with Na or tetrabutylammonium, NaOH or tetrabutylammonium hydroxide may be used during preparation of the catalyst composition, respectively. When the H is substituted with K, Li, or Cs, suitable compounds for the substitutions may be used. Because such a substitution is known to this art, its detailed description is omitted.

In an embodiment, the binder resins may be used singularly or in combination. They may be used along with non-conductive polymers to improve adherence with a polymer electrolyte membrane. The binder resins may be used in a controlled amount to adapt to their purposes.

Non-limiting examples of the non-conductive polymers include polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE), chlorotrifluoroethylene-ethylene copolymers (ECTFE), polyvinylidenefluoride, polyvinylidenefluoride-hexafluoropropylene copolymers (PVdF-HFP), dodecylbenzenesulfonic acid, sorbitol, or combinations thereof.

In one embodiment, an electrode substrate of an anode is the same as that of the cathode except that it does not include the hydrocarbon fuel catalyst. Therefore, an additional description thereof is omitted.

The polymer electrolyte membrane of the membrane-electrode assembly may generally include a proton conductive polymer resin. In an embodiment, the proton conductive polymer resin may be a polymer resin having a cation exchange group selected from the group consisting of a sulfonic acid group, a carboxylic acid group, a phosphoric acid group, a phosphonic acid group, and derivatives thereof, at its side chain.

Non-limiting examples of the polymer resin include at least one selected from the group consisting of fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In an embodiment, the proton conductive polymer is at least one selected from the group consisting of poly(perfluorosulfonic acid) (NAFION™), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), or poly(2,5-benzimidazole).

In one embodiment, the hydrogen (H) in the proton conductive group of the proton conductive polymer can be substituted with Na, K, Li, Cs, or tetrabutylammonium. When the H in the ionic exchange group of the terminal end of the proton conductive polymer side is substituted with Na or tetrabutylammonium, NaOH or tetrabutylammonium hydroxide may be used during preparation of the catalyst composition, respectively. When the H is substituted with K, Li, or Cs, suitable compounds for the substitutions may be used. Since such a substitution is known to this art, a detailed description thereof is omitted.

A fuel cell system including the membrane-electrode assembly of the present invention includes at least one electricity-generating element, a fuel supplier, and an oxidant supplier. The electricity-generating element includes an MEA that includes a polymer electrolyte membrane, and a cathode and an anode positioned at both sides of the polymer electrolyte membrane. It generates electricity through oxidation of fuel and reduction of an oxidant.

The fuel supplier plays a role of supplying the electricity generating element with a fuel including hydrogen. The fuel includes liquid or gaseous hydrogen, or a hydrocarbon-based fuel such as methanol, ethanol, propanol, butanol, or natural gas.

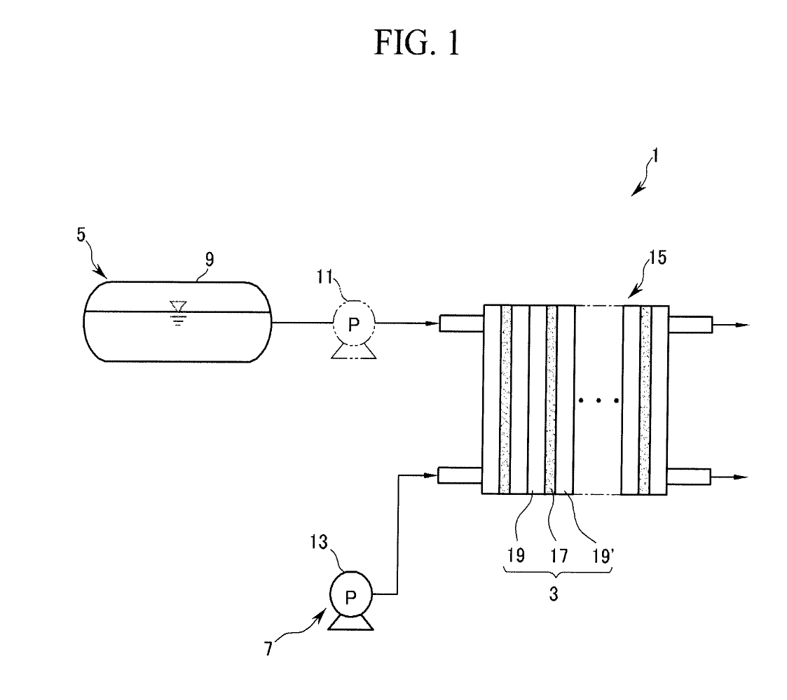

FIG. 1 illustrates a fuel cell system according to one embodiment of the invention, wherein a fuel and an oxidant are provided to the electricity generating element through pumps, but the present invention is not limited to such structures. The fuel cell system of the present invention alternatively includes a structure wherein a fuel and an oxidant are provided in a diffusion manner.

A fuel cell system 1 includes at least one electricity generating element 3 that generates electrical energy through an electrochemical reaction of a fuel and an oxidant, a fuel supplier 5 for supplying a fuel to the electricity generating element 3, and an oxidant supplier 7 for supplying an oxidant to the electricity generating element 3.

In addition, the fuel supplier 5 is equipped with a tank 9 that stores fuel, and a pump 11 that is connected therewith. The fuel pump 11 supplies fuel stored in the tank 9.

The oxidant supplier 7, which supplies the electricity generating element 3 with an oxidant, is equipped with at least one pump 13 for supplying an oxidant.

The electricity generating element 3 includes a membrane-electrode assembly 17 that oxidizes hydrogen or a fuel and reduces an oxidant, separators 19 and 19′ that are respectively positioned at opposite sides of the membrane-electrode assembly and supply hydrogen or a fuel, and an oxidant. At least one electricity-generating element 3 is composed in a stack 15.

The following examples illustrate the present invention in more detail. However, it is understood that the present invention is not limited by these examples.

### EXAMPLE 1

IrCl₃ (Aldrich Co.), and H₂PtCl₆.6H₂O were dissolved in water, preparing an Ir and Pt precursor solution. Then, a carbon cloth (E-TeK Co.) was impregnated in the solution and reacted at 500° C. for 1 hour under an H₂ atmosphere, thereby preparing an electrode substrate impregnated with Pt—Ir. Pt was impregnated in an amount of 0.5 wt % based on the weight of an electrode substrate, while Ir was impregnated in an amount of 0.1 wt %.

The cathode substrate was coated with a catalyst composition for a cathode including 88 wt % of a Pt black (Johnson Matthey) catalyst, 5 wt % of NAFION™/H₂O/2-propanol (Solution Technology, Inc.), and 12 wt % of a binder, thereby preparing a cathode.

An anode was prepared by coating a carbon cloth as an electrode substrate (SGL GDL 10DA) with a catalyst composition for an anode including 88 wt % of a Pt—Ru black (Johnson Matthey) catalyst, and using 12 wt % of a 5 wt % concentration of NAFION™/H₂O/2-propanol (Solution Technology, Inc.) as a binder.

Herein, the catalysts were loaded in an amount of 5 mg/cm² on each anode and cathode.

An MEA was prepared by using the fabricated anode and cathode, and a commercially available NAFION™ 115 (perfluorosulfonic acid) polymer electrolyte membrane.

### COMPARATIVE EXAMPLE 1

A cathode was prepared according to Example 1, except that a carbon paper electrode substrate was not coated with a methanol oxidizing catalyst.

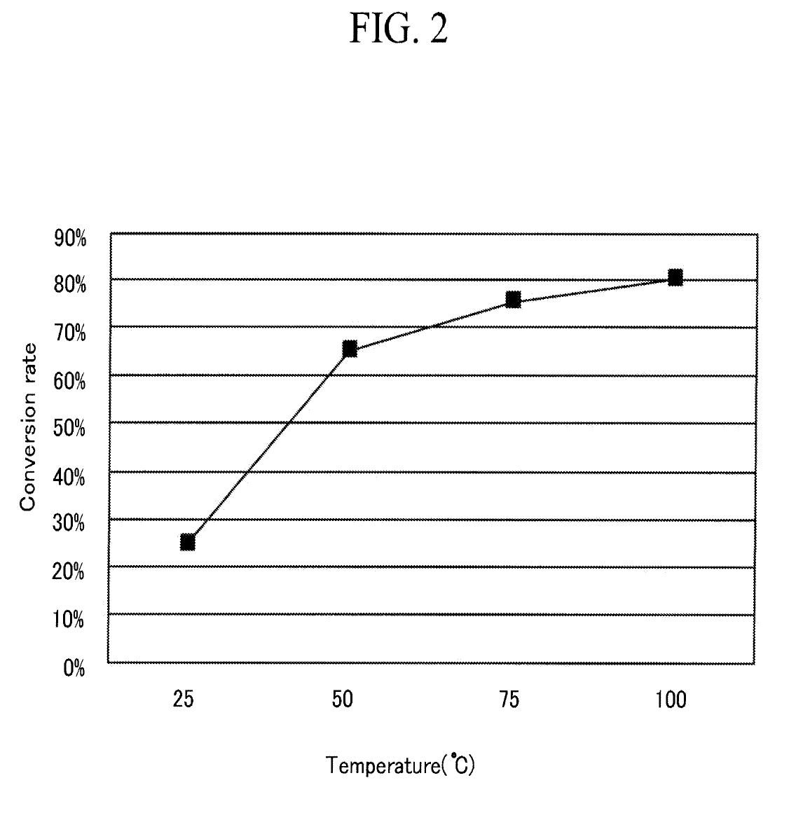

The cathode substrate (10 cm² area) prepared according to Example 1 was injected with 5M methanol at a speed of 100 cc/min to measure a conversion rate by methanol oxidation. The result is provided in FIG. 2. The temperature in FIG. 2 denotes that of a reactor. As shown in FIG. 2, the temperature of the reactor gradually increased due to methanol oxidation as the methanol was supplied therewith.

Next, methanol was supplied to unit cells according to Example 1 and Comparative Example 1 to operate them. Then, the fuel cells were measured regarding power density at each of 0.45V, 0.4V, and 0.35V at 30° C. The results are provided in Table 1.

TABLE 1

| | | 30° C. | | | Cathode |
|---|---|---|---|---|---|
| | | 0.45 V | | | temperature |
| | | (mW/ | 0.40 V | 0.35 V | (at 0.35 V) |
| | Fuel | cm²) | (mW/cm²) | (mW/cm²) | (° C.) |
| Comparative | 3M | 37 | 48 | 55 | 43 |
| Example 1 | methanol | | | | |
| Example 1 | | 39 | 53 | 63 | 49 |
| Comparative | 5M | 21 | 30 | 36 | 48 |
| Example 1 | methanol | | | | |
| Example 1 | | 23 | 40 | 48 | 56 |

As shown in Table 1, a fuel cell of Example 1 using a cathode substrate impregnated with Pt—Ir had much better power output density than that of Comparative Example 1. The cathode of Example 1 also had a higher temperature than that of Comparative Example 1, showing that oxidation of methanol occurred on the cathode.

Since an MEA for a DOFC of the present invention includes a hydrocarbon fuel oxidizing catalyst on a cathode substrate, it may prevent the hydrocarbon fuel crossing over toward a cathode from leaking and gasifying, and gain a high power output.

While this invention has been described in connection with what is considered to be exemplary embodiments, it is to be understood that the invention is not limited to the disclosed embodiments, but, on the contrary, is intended to cover various modifications and equivalent arrangements included within the spirit and scope of the appended claims and equivalents thereof.

What is claimed is:

1. A membrane-electrode assembly for direct oxidation fuel cell, comprising:
an anode;
a cathode, comprising an electrode substrate including a hydrocarbon fuel oxidizing catalyst, and a cathode catalyst layer disposed on the electrode substrate; and
a polymer electrolyte membrane interposed between the anode and the cathode.

2. The membrane-electrode of claim 1, wherein the hydrocarbon fuel oxidizing catalyst comprises first and second catalysts, wherein the first catalyst is selected from the group consisting of Rh, Pd, Ir, Au, and combinations thereof.

3. The membrane-electrode assembly of claim 2, wherein the second catalyst comprises a material selected from the group consisting of Pt, Ru, osmium, platinum-ruthenium alloys, platinum-osmium alloys, platinum-palladium alloys, platinum-M alloys, and combinations thereof, where M is at least one transition element selected from the group consisting of Ga, Ti, V, Cr, Mn, Fe, Co, Ni, Cu, Zn, Sn, Mo, W, Rh, and combinations thereof.

4. The membrane-electrode assembly of claim 2, wherein the hydrocarbon fuel oxidizing catalyst comprises Ir as a first catalyst and Pt as a second catalyst.

5. The membrane-electrode assembly of claim 2, wherein the hydrocarbon fuel oxidizing catalyst is supported in a carrier selected from the group consisting of Al₂O₃, zeolite, TiO₂, SiO₂, MnO₂, Mn₂O₃, zirconia, acetylene black, denka black, activated carbon, ketjen black, graphite, and combinations thereof.

6. The membrane-electrode assembly of claim 1, wherein the electrode substrate comprises the hydrocarbon fuel oxidizing catalyst in an amount ranging from 1 to 10 wt %.

7. The membrane-electrode assembly of claim 1, wherein the electrode substrate is selected from the group consisting of carbon paper, carbon cloth, carbon felt, and metal cloth.

8. The membrane-electrode assembly of claim 1, wherein the cathode catalyst layer comprises at least one catalyst comprising at least one catalytic metal selected from the group consisting of platinum, ruthenium, osmium, platinum-ruthenium alloys, platinum-osmium alloys, platinum-palladium alloys, platinum-M alloys, and combinations thereof, where M is at least one metal selected from the group consisting of Ga, Ti, V, Cr, Mn, Fe, Co, Ni, Cu, Zn, Sn, Mo, W, Rh, and combinations thereof; and the catalytic metal is supported on a carrier.

9. The membrane-electrode assembly of claim 8, wherein the carrier is a carbon material or an inorganic material.

10. A direct oxidation fuel cell system comprising:
an electricity generating element for generating electricity through oxidation of a fuel and reduction of an oxidant, comprising:
a membrane-electrode assembly comprising:
an anode;
a cathode, comprising an electrode substrate including a hydrocarbon fuel oxidizing catalyst, and a cathode catalyst layer disposed on the electrode substrate;
a polymer electrolyte membrane interposed between the anode and the cathode;
a fuel supplier adapted to supply the fuel to the electricity generating element; and
an oxidant supplier adapted to supply the oxidant to the electricity generating element.

11. The direct oxidation fuel cell system of claim 10, wherein the fuel is a hydrocarbon fuel.

12. The direct oxidation fuel cell system of claim 11, wherein the fuel is selected from the group consisting of methanol, ethanol, propanol, butanol, and natural gas.

13. The direct oxidation fuel cell system of claim 10, wherein the direct oxidation fuel cell system is a passive type.
